(19) United States
(12) Patent Application Publication
(10) Pub. No.: US 2011/0078742 A1
(43) Pub. Date: Mar. 31, 2011

(54) APPARATUS AND METHOD FOR SEARCHING FOR BROADCAST PROGRAM IN A DIGITAL BROADCASTING RECEIVER

(75) Inventor: Young-Seok KANG, Suwon-si (KR)

(73) Assignee: Samsung Electronics Co. Ltd., Suwon-si (KR)

(21) Appl. No.: 12/894,942

(22) Filed: Sep. 30, 2010

(30) Foreign Application Priority Data
Sep. 30, 2009 (KR) 10-2009-0093172

(51) Int. Cl. H04N 5/445

(52) U.S. Cl. 725/53

(57) ABSTRACT

A method and apparatus for searching for a broadcast program in a digital broadcasting receiver are provided, in which a program search option window including search options for a program search is displayed on a display by a screen generator, upon receipt of a program search request from a user, broadcast programs matching a search option selected from among the search options included in the program search option window by the user are searched for by the screen generator, and a program search result screen including a list of the detected broadcast programs is displayed on the display by the screen generator.

### PRIORITY

This application claims priority under 35 U.S.C. §119(a) to a Korean Patent Application filed in the Korean Intellectual Property Office on Sep. 30, 2009 and assigned Ser. No. 10-2009-0093172, the entire disclosure of which is incorporated herein by reference.

### BACKGROUND OF THE INVENTION

1. Field of the Invention

The present invention generally relates to a digital broadcasting receiver, and more particularly, the present invention relates to an apparatus and method for searching for a broadcast program in a digital broadcasting receiver.

2. Description of the Related Art

Along with the recent shift from analog broadcasting to digital broadcasting in broadcasting technology, a head-end, which provides broadcast content, now creates digital broadcast programs and transmits them to receivers. Digital broadcasting can provide high-quality broadcasting services to viewers.

FIG. 1 illustrates the configuration of a general digital broadcasting system. Referring to FIG. 1, a head-end 100 receives broadcast content from a content provider, modulates and encodes the broadcast contents suitably for transmission over a communication network 102, and transmits broadcast programs and an Electronic Program Guide (EPG) including information about the broadcast programs to a receiver 104.

If the digital broadcasting system is a Digital Multimedia Broadcasting (DMB) system, the communication network 102 may serve as a terrestrial DMB transmitter or a gap filler repeater that relays a satellite DMB signal, and the receiver 104 may serve as a DMB receiver. If the digital broadcasting system is an Internet Protocol TV (IPTV) system, the communication network 102 may be an IP-based Internet and the receiver 104 may be a set-top box.

Since a digital broadcasting system is capable of providing a large number of broadcast programs, for example, hundreds of broadcast programs to viewers, a viewer must switch through many broadcast programs one-by-one in order to select a desired broadcast program among a plurality of broadcast programs.

Accordingly, there exists a need for reducing time taken for a viewer to search for a desired broadcast program in a digital broadcasting system.

### SUMMARY OF THE INVENTION

An aspect of embodiments of the present invention is to address at least the problems and/or disadvantages and to provide at least the advantages described below. Accordingly, an aspect of the embodiments of the present invention is to provide a method and apparatus for selecting a broadcast program in a digital broadcasting receiver.

Another aspect of the embodiments of the present invention is to provide a method and apparatus for searching for a broadcast program upon user selection using a digital broadcasting receiver.

A further aspect of the embodiments of the present invention is to provide a method and apparatus for searching for a user-preferred broadcast program using a digital broadcasting receiver.

In accordance with an aspect of the embodiments of the present invention, there is provided a method for searching for a broadcast program in a digital broadcasting receiver, in which a program search option window including search options for a program search is displayed on a display by a screen generator, upon receipt of a program search request from a user, broadcast programs matching a search option selected from among the search options included in the program search option window by the user are searched for by the screen generator, and a program search result screen including a list of the detected broadcast programs is displayed on the display by the screen generator.

In accordance with another aspect of the embodiments of the present invention, there is provided an apparatus for searching for a broadcast program in a digital broadcasting receiver, in which a user interface receives a program search request signal and a search option selection signal from a user, and a screen generator displays a program search option window including search options for a program search on a display, upon receipt of the program search request signal from the user, searches for broadcast programs matching a search option selected by the user from among the search options included in the program search option window, and displays a program search result screen including a list of the detected broadcast programs on the display.

### BRIEF DESCRIPTION OF THE DRAWINGS

The above and other objects, features and advantages of certain embodiments of the present invention will be more apparent from the following detailed description taken in conjunction with the accompanying drawings, in which:

FIG. 1 illustrates the configuration of a general digital broadcasting system;

FIG. 2 is a block diagram of a digital broadcasting receiver according to an embodiment of the present invention;

FIG. 3 is a flowchart illustrating a method for searching for a broadcast program in the digital broadcasting receiver according to an embodiment of the present invention;

FIG. 4 is a flowchart illustrating a method for searching for a broadcast program in the digital broadcasting receiver according to another embodiment of the present invention;

FIG. 5 illustrates a program search option window displayed on a display according to an embodiment of the present invention;

FIG. 6 illustrates a program search result screen that displays a list of broadcast programs detected based on search options on the display according to an embodiment of the present invention; and

FIG. 7 illustrates a program search option window and a program search result screen that are simultaneously displayed according to another embodiment of the present invention.

Throughout the drawings, the same drawing reference numerals will be understood to refer to the same elements, features and structures.

### DETAILED DESCRIPTION OF THE EMBODIMENTS OF THE PRESENT INVENTION

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

FIG. 2 is a block diagram of a digital broadcasting receiver 200 according to an embodiment of the present invention.

Referring to FIG. 2, a receiver 202 receives broadcast programs and an Electronic Program Guide (EPG), including information necessary to demodulate the broadcast programs over the communication network 102, demodulates the broadcast programs using the information included in the EPG, and provides the demodulated broadcast programs to a screen generator 212.

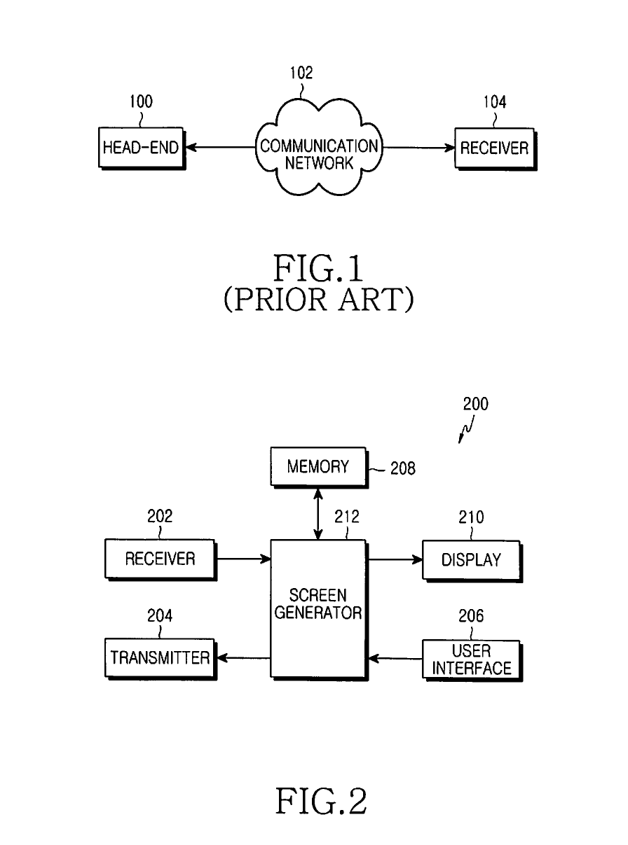

In case of an interactive digital broadcasting system such as IPTV, a transmitter 204 transmits user-selected information to the head-end 100 (FIG. 1) over the communication network 102 (FIG. 1). A user interface 206 senses a signal from a user and provides the sensed signal to the screen generator 212. Signals that the user interface 206 receives from the user may include a program selection signal, a program search request signal, a volume up/down signal, a direction selection signal like left, right, up or down, and other broadcast program-related control signals such as a program search end request, which requests a program search to stop.

The user interface 206 may receive signals from the user in various manners depending on the type of the user interface 206. For example, if the user interface 206 supports infrared communication, the interface may input a control signal using an external control device such as a remote controller. If the user interface 206 employs a direct input scheme, the user may input a signal by manipulating a touch screen or a key of the digital broadcasting receiver 200.

A memory 208 stores the broadcast programs and the EPG received through the receiver 202. Further, the memory 208 stores user-selected search options for selecting a broadcast program and a list of broadcast programs matching the search options according to an embodiment of the present invention.

In accordance with an embodiment of the present invention, the screen generator 212 generates a program search option window and outputs the program search option window to a display 210. Additionally, the screen generator 212 provides the broadcast programs or the EPG received from the receiver 202 to the display 210 upon user selection. Upon receipt of a program search request through the user interface 206, the screen generator 212 creates a program search option window including predetermined search options for a program search and controls the display 210 to display the program search option window. Also, the screen generator 212 searches for broadcast programs matching search options selected by the user from among search options displayed in the program search option window.

The screen generator 212 stores a set of search options for a program search by the user through the user interface 206 in the form of predetermined data. After searching for broadcast programs matching the user-set search options, the screen generator 212 stores a list of the broadcast programs in the memory 208. Then, upon receipt of a program search end request from the user, the screen generator 212 controls the display 210 to display a program search result screen including the stored list of broadcast programs to the user.

When displaying the program search option window upon user request, the screen generator 212 may control the display 210 to further display a previous user-selected search option. Thus, the screen generator 212 reads the previous user-selected search option from the memory 208. Additionally, when outputting a program search result screen after searching for broadcast programs matching user-selected search options, the screen generator 212 may control the display 210 to arrange the broadcast programs by at least one of time, broadcasting station, and genre in the program search result screen.

The screen generator 212 can acquire information about broadcast programs such as the genres, start and end times, broadcasting stations, and video qualities of the broadcast programs and information indicating whether the broadcast programs are initial airings or re-airings, from the EPG received through the receiver 202. Thus, the digital broadcasting receiver 200 can search for broadcast programs matching user-selected search options. In the embodiment of the present invention, with regard to viewing rate as a search option, the digital broadcasting receiver 200 requests information about the viewing rates of broadcast programs to the head-end and receives the viewing rate information from the head-end, or the head-end may transmit the viewing rate information in the EPG.

In another embodiment of the present invention, each time the user selects a search option while the program search option window is displayed on the display 210, the screen generator 212 may control the display 210 to display a program search result window, including a list of broadcast programs matching the selected search option among the broadcast programs received through the receiver, at a side of the program search option window.

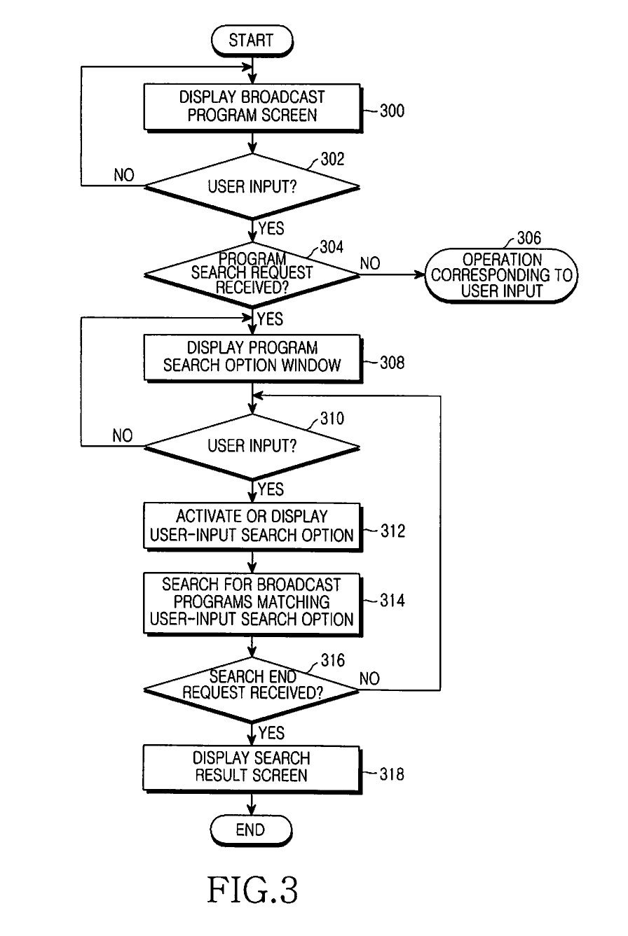

FIG. 3 is a flowchart illustrating a method for searching for a broadcast program in the digital broadcasting receiver according to an embodiment of the present invention.

Referring to FIG. 3, the digital broadcasting receiver provides a broadcast program screen to the user in step 300 and monitors reception of a signal from the user in step 302. Upon receipt of a signal from the user, the digital broadcasting receiver determines whether the received signal is a program search request in step 304. If the received signal is not a program search request, the digital broadcasting receiver performs an operation corresponding to the signal received from the user in step 306. This operation is outside the scope of the present invention and thus will not be described in detail herein.

If the received signal is a program search request in step 304, the digital broadcasting receiver displays a program search option window according to the present invention in step 308.

The digital broadcasting receiver monitors reception of a signal from the user in step 310. Upon receipt of a signal from the user, the digital broadcasting receiver activates or displays a search option corresponding to the received signal in step 312. Activation of a search option means that the search option is marked or indicated by a predetermined symbol. For example, if the search option is “genre”, sub-options for searching for broadcast programs by genre may be “sports”, “movie”, “comedy”, and “drama”. To indicate selection of each sub-option, a predetermined symbol may be used. In this case, if the user selects “sports”, a symbol corresponding to “sports” is marked or displayed so as to confirm the selection of “sports” to the user.

Displaying of a user-input search option includes displaying a program search option window number or character when such a number or character is received directly from the user, for a program search. For instance, if a search option is set to search for broadcast programs that start from a first time before a current time to broadcast programs that start within a second time after the current time, the digital broadcasting receiver receives numbers corresponding to the “first time” and the “second time” from the user and displays the received numbers in the program search option window. In step 314, the digital broadcasting receiver searches for broadcast programs matching the search options activated or displayed in step 312.

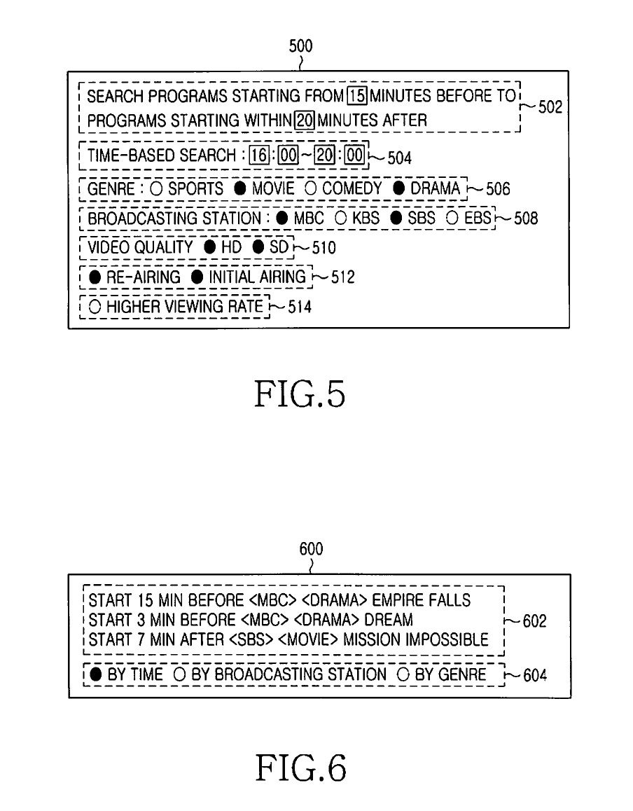

Steps 312 and 314 of FIG. 3 will be described below in greater detail with reference to FIG. 5.

FIG. 5 illustrates a program search option window 500 displayed on the display 210 (from FIG. 2) according to an embodiment of the present invention.

Referring to FIG. 5, reference numerals 502 to 514 denote search options. Reference numeral 502 denotes a search option set to search for broadcast programs that start from a first time before a current time to broadcast programs that start within a second time after the current time. In the illustrated case of FIG. 5, the first time is set to 15 minutes and the second time is set to 20 minutes, by way of example. The first time and the second time may be changed according to user inputs and a search may be performed by setting only one of the first time and the second time. For instance, if the user enters only the first time, the digital broadcasting receiver searches for all broadcast programs that started from the first time before the current time. If the user enters only the second time, the digital broadcasting receiver searches for all broadcast programs that will start within the second time after the current time. If the user interface operates by infrared communication, the user may enter the first time and the second time using number keys of a remote controller.

Reference numeral 504 denotes a search option for searching for broadcast programs that start within a user-set time period. For instance, if the user interface operates by infrared communication, the user enters a time for a program search using number keys or arrow keys of the remote controller and then the digital broadcasting receiver searches for broadcast programs that start within the user-entered time period. For example, the user may set the search option “16:00” to “20:00” as illustrated in FIG. 5. Additionally, only one of the two values may be entered. For example, if the user enters only “16:00” in the time-based search option, the digital broadcasting receiver searches for all broadcast programs that start at or after 16:00.

Reference numeral 506 denotes a search option for searching for broadcast programs of a user-selected program genre. While there are sub-options, “sports”, “movie”, “comedy” and “drama” under a search option “genre” in FIG. 5, other sub-options such as “game”, “music”, and “documentary” may be added. The sub-options ‘movie’ and ‘drama’ are shown as selected in the search option “genre.” In this case, the digital broadcasting receiver searches for broadcast programs that are movies or dramas.

Reference numeral 508 denotes a search option for searching for broadcast programs airing from a user-selected broadcasting station. In FIG. 5, sub-options “MBC” and “KBS” are shown as selected in a search option “broadcasting station.” Then, the digital broadcasting receiver searches for all broadcast programs provided by MBC or SBS. While the search option “broadcasting station” has sub-options “MBC”, “KBS”, “SBS” and “EBS” in FIG. 5, other domestic or overseas broadcasting stations such as “CNN” and “BBC” may be added as sub-options of the search option “broadcasting station”.

Reference numeral 510 denotes a search option “video quality” for searching for broadcast programs having a user-selected video quality. While the search option “video quality” is branched into sub-options “High Definition (HD)” and “Standard Definition (SD)” in FIG. 5, specific resolutions such as 576 p (progress), 720 p, 1080 i (interlace), and 1080 p may be given as sub-options of the search option “video quality”. In this case, 576 p and 720 p fall into the category of SD and 1080 i and 1080 p fall into the category of HD. In FIG. 5, both “SD” and “HD” are shown as selected.

Reference numeral 512 denotes a search option for searching for broadcast programs, which are initial airings or re-airings. In the illustrated case of FIG. 5, the user selects both “initial airing” and “re-airing.” In this case, the digital broadcasting receiver searches for broadcasting programs that are initial airings or re-airings.

Reference numeral 514 denotes a search option used to search broadcast programs received from the head-end according to their viewing rates. If search option 514 is selected, the digital broadcasting receiver may search broadcast programs received from the head-end according to their viewing rates. For example, the digital broadcasting receiver may provide broadcast programs in a descending order of viewing rate. Specifically, the digital broadcasting receiver may provide only the ten top ranking broadcast programs to the user.

While not shown in FIG. 5, the digital broadcasting receiver may include a search option for searching for broadcast programs having a play time equal to less than a user-set value in the program search option window. For example, if the user sets a total play-time to 2 hours, the digital broadcasting receiver searches for broadcast programs that run for 2 or fewer hours among the broadcast programs received from the head-end.

Referring to FIG. 3 again, upon the receipt of a search end request from the user in step 316, the digital broadcasting receiver displays a list of the broadcast programs matching the user-selected search options in step 318. Otherwise, the digital broadcasting receiver monitors reception of a signal from the user in step 310.

Step 314 of FIG. 3 will be described in greater detail with reference to FIG. 6.

FIG. 6 illustrates a program search result screen 600 that displays broadcast programs detected according to search options on the display 210 according to an embodiment of the present invention.

Referring to FIG. 6, reference numeral 600 denotes a list of broadcast programs matching user-selected search options. The digital broadcasting receiver displays the program search result screen 600 including the broadcast programs matching the search options selected in the program search option window 500 illustrated in FIG. 5. The search result screen 600 may simultaneously display a list of the detected broadcast programs 602 and an ordering type list 604 that allows the user to select an ordering type for arranging the detected broadcast programs. The user may select a desired ordering type in the ordering type list 604 to arrange the detected broadcast programs according to the selected ordering type. In the illustrated case of FIG. 6, the user selects “by time.” In this case, the digital broadcasting receiver arranges the broadcast programs in the order of earlier start time on the program search result screen 600.

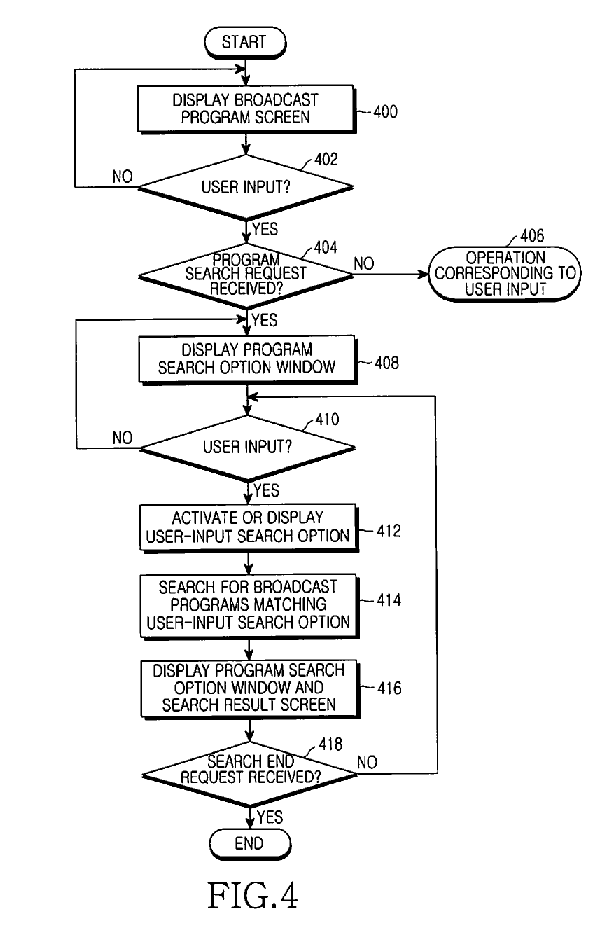

Referring back to FIG. 4, FIG. 4 is a flowchart illustrating a method for searching for a broadcast program in the digital broadcasting receiver according to another embodiment of the present invention. In FIG. 4, a program search option window and a program search result screen are simultaneously displayed. That is, each time the user selects a search option in the program search option window, the digital broadcasting receiver may provide the user with a list of broadcast programs matching the selected search options in the program search result screen.

Steps 400 to 414 are performed in the same manner as steps 300 to 314 of FIG. 3 and, thus, their detailed description is not provided herein. In step 416, the digital broadcasting receiver displays a program search option window and a program search result screen simultaneously. The search result screen displays a list of broadcast programs matching a search option selected through the program search option window. The search result screen is shown at a side of the program search option window.

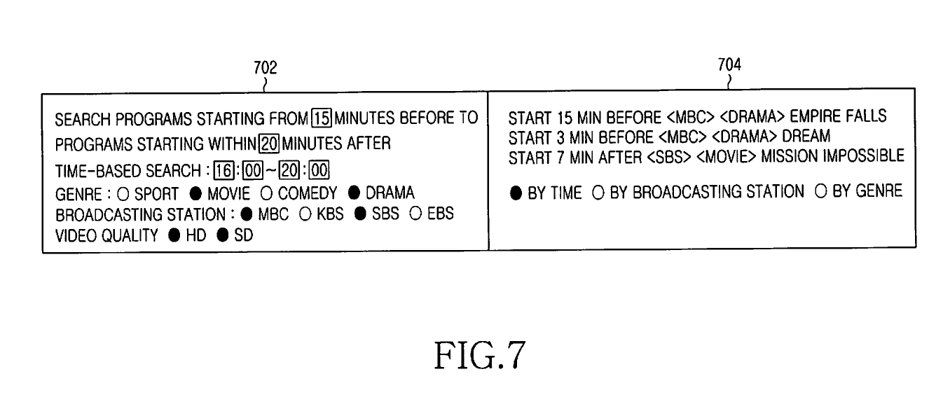

FIG. 7 illustrates a program search option window 702 and a program search result screen 704 that are displayed simultaneously according to another embodiment of the present invention.

Referring to FIG. 7, each time the user selects a search option in the program search option window 702, the program search result screen 704 displays broadcast programs matching the selected search option. While the program search result screen 704 is at the right side of the program search option window 702 in FIG. 7, it is merely an example. Hence, the search result screen 704 may be placed at any position such as above, under, or at the left or right side of the program search option window 702. Additionally, the program search result screen 704 may be superimposed on the program search condition window 702, like a pop-up window. That is, the program search result screen 704 is displayed in real time beside the program search option window 702, upon completion of a broadcast program search matching user-selected search options in this embodiment of the present invention.

Referring back to FIG. 4, upon receipt of a program search end request from the user in step 418, the digital broadcasting receiver, which has displayed the program search window and the program search result screen in step 416 ends the program search operation. Otherwise, the digital broadcasting receiver monitors reception of a signal from the user in step 410.

As is apparent from the above description of the present invention, time taken for a viewer to search for a desired digital broadcast program in a digital broadcasting receiver can be reduced.

The present invention can also be embodied as computer-readable codes on a computer-readable recording medium. The computer-readable recording medium is any data storage device that can store data, which can thereafter be read by a computer system. Examples of computer-readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, function programs, source code, and source code segments for accomplishing the present invention can be easily construed as within the scope of the invention by programmers skilled in the art to which the present invention pertains.

While the invention has been shown and described with reference to certain embodiments of the present invention thereof, it will be understood by those skilled in the art that various changes in form and details may be made therein without departing from the spirit and scope of the present invention as defined by the appended claims and their equivalents.

What is claimed is:

1. A method for searching for a broadcast program in a digital broadcasting receiver, comprising:
displaying a program search option window including a plurality of search options for a program search on a display by a screen generator, upon receipt of a program search request from a user;
searching for broadcast programs matching a search option selected by the user from among the plurality of search options included in the program search option window by the screen generator; and
displaying a program search result screen including a list of the detected broadcast programs on the display by the screen generator.

2. The method of claim 1, wherein displaying the program search option window comprises displaying, in the presence of a previous service option selected by the user, the previous service option on the program search option window.

3. The method of claim 1, wherein displaying the program search result screen comprises displaying the program search result screen in real time at a side of the program search option window, upon completion of the search for the list of the broadcast programs matching the selected search option.

4. The method of claim 1, wherein the search options in the program search option window include a search option for searching for broadcast programs that start from a first time before a current time or broadcast programs that start within a second time after the current time.

5. The method of claim 1, wherein the search options in the program search option window include a search option for searching for broadcast programs that start within a time period set by the user.

6. The method of claim 1, wherein the search options in the program search option window include a search option for searching for broadcast programs of a genre set by the user.

7. The method of claim 1, wherein the search options in the program search option window include a search option for searching for broadcast programs provided by a broadcasting station set by the user.

8. The method of claim 1, wherein the search options in the program search option window include a search option for searching for broadcast programs provided by a video quality set by the user and the video quality includes High Definition (HD) or Standard Definition (SD).

9. The method of claim 1, wherein the search options in the program search option window include a search option for searching for broadcast programs that are initial airings or re-airings.

10. The method of claim 1, wherein the search options in the program search option window include a search option for searching for broadcast programs according to viewing rate among broadcast programs provided by a head-end.

11. The method of claim 1, wherein the search options in the program search option window include a search option for searching for broadcast programs having a play-time less than or equal to a value set by the user among broadcast programs provided by a head-end.

12. The method of claim 1, wherein displaying the program search result screen comprises displaying the program search result screen by arranging the detected broadcast programs by at least one of time, broadcasting station, and program genre.

13. An apparatus for searching for a broadcast program in a digital broadcasting receiver, comprising:
a user interface for receiving a program search request signal and a search option selection signal from a user; and
a screen generator for displaying a program search option window including search options for a program search on a display, upon receipt of the program search request signal from the user, searching for broadcast programs matching a search option selected by the user from among the search options included in the program search option window, and displaying a program search result screen including a list of the detected broadcast programs on the display.

14. The apparatus of claim 13, wherein in the presence of a previous service option selected by the user, the screen generator displays the previous service option on the program search option window.

15. The apparatus of claim 13, wherein the screen generator displays the program search result screen in real-time at a side of the program search option window, upon completion of the search for the list of the broadcast programs matching the selected search option.

16. The apparatus of claim 13, wherein the search options in the program search option window include a search option for searching for broadcast programs that start from a first time before a current time or broadcast programs that start within a second time after the current time.

17. The apparatus of claim 13, wherein the search options in the program search option window include a search option for searching for broadcast programs that start within a time period set by the user.

18. The apparatus of claim 13, wherein the search options in the program search option window include a search option for searching for broadcast programs of a genre set by the user.

19. The apparatus of claim 13, wherein the search options in the program search option window include a search option for searching for broadcast programs provided by a broadcasting station set by the user.

20. The apparatus of claim 13, wherein the search options in the program search option window include a search option for searching for broadcast programs provided by a video quality set by the user and the video quality is High Definition (HD) or Standard Definition (SD).

21. The apparatus of claim 13, wherein the search options in the program search option window include a search option for searching for broadcast programs that are initial airings or re-airings.

22. The apparatus of claim 13, wherein the search options in the program search option window include a search option for searching for broadcast programs according to viewing rate among broadcast programs provided by a head-end.

23. The apparatus of claim 13, wherein the search options in the program search option window include a search option for searching for broadcast programs having a play time less than or equal to a value set by the user among broadcast programs provided by a head-end.

24. The apparatus of claim 13, wherein the screen generator displays the program search result screen by arranging the detected broadcast programs by at least one of time, broadcasting station, and program genre.
